(19) United States
(12) Patent Application Publication
(10) Pub. No.: US 2002/0131390 A1
(43) Pub. Date: Sep. 19, 2002

(54) Cancellation of non-orthogonal signal in CDMA wireless communications systems

(76) Inventors: Wen-Yi Kuo, Marlboro Township, NJ (US); Lei Song, Edison, NJ (US)

Correspondence Address: MATHEWS, COLLINS, SHEPHERD & GOULD, P.A., 100 THANET CIRCLE, SUITE 306, PRINCETON, NJ, 08540-3674, US

(21) Appl. No.: 10/093,706

(22) Filed: Mar. 8, 2002

Related U.S. Application Data
(60) Provisional application No. 60/274,754, filed on Mar. 9, 2001.

(51) Int. Cl. H04J 3/06

(52) U.S. Cl. 370/342; 370/350

(57) ABSTRACT

A method and apparatus that can cancel the non-orthogonal code channel signals to minimize the interference in the detection for desired signals, first uses the channel estimate via pilot signal to reconstruct the signal at non-orthogonal code channel (e.g., SCH), then removes (subtracts) the reconstructed signal from the received signal before the decoding and detection of other code channels. The cancellation of interference from non-orthogonal signal can significantly improve the performance of the detection of the desired signal (user data or broadcast data) and thus more system capacity can be obtained.

### CROSS REFERENCES TO RELATED APPLICATIONS

This application claims the benefit under 35 U.S.C. 119(e) of U.S. Provisional Application Serial No. 60/274,754 filed on Mar. 9, 2001.

### FIELD OF THE INVENTION

This invention relates to the field of wireless digital communications, and more particularly to receiver signal processing for such signals.

### BACKGROUND OF THE INVENTION

Wireless communications facilitates the delivery of information between the transmitter and the receiver without a physical wired connection. Such advantage translates to the freedom of mobility for the users and to the savings of wiring nuisance for the users. However, spectrum has become scarce resource as the usage of wireless communications for various applications becomes more popular. Therefore the efficiency of using spectrum presents challenges for the wireless industry. In order to maximize efficient spectrum utilization, various multiple access methods have been proposed to achieve the goal.

First generation cellular communications systems, Advanced Mobile Phone Services (AMPS) employed the Frequency Division Multiple Access (FDMA) method and provided voice communication services in the early days. Second generation cellular communications systems improved the spectrum efficiency by using more digital processing of signals and employed Time Division Multiple Access (TDMA) method in GSM and IS-136 systems and Code Division Multiple Access (CDMA) method in IS-95 systems. While second generation systems typically provide two to five times voice capacity over the first generation systems, data capabilities of second-generation systems are very limited.

Recent rapid commercial development of Internet and multimedia applications has created a strong demand for wireless cellular systems capable of providing sufficient bandwidth. In addition, further improvement of voice capacity in spectrum efficiency is in great demand as the spectrum allocated for service is very limited. This scarcity results in high licensing fees for the available spectrum.

Therefore there is a need to improve the system capacity and spectrum efficiency for wireless communication systems.

### SUMMARY OF THE INVENTION

The present invention is a method and apparatus that can cancel the non-orthogonal code channel signals to minimize the interference in the detection for desired signals. The present invention first uses the channel estimate via pilot signal to reconstruct the signal at non-orthogonal code channel (e.g., SCH). Then such reconstructed signal is removed (subtracted) from the received signal before the decoding and detection of other code channels. The cancellation of interference from non-orthogonal signal can significantly improve the performance of the detection of the desired signal (user data or broadcast data) and thus more system capacity can be obtained.

### BRIEF DESCRIPTION OF THE DRAWINGS

A more complete understanding of the present invention may be obtained from consideration of the following description in conjunction with the drawings in which:

FIG. 1 is a block diagram of a typical WCDMA downlink transmission (from base station to terminal) signal coding;

FIG. 2 is a block diagram of the architecture to suppress the interference from non-orthogonal channels in a typical WCDMA downlink transmission; and, FIG. 3 is a block diagram of an exemplary embodiment of SCH interference cancellation for multiple fingers scenarios.

### DETAILED DESCRIPTION OF VARIOUS ILLUSTRATIVE EMBODIMENTS

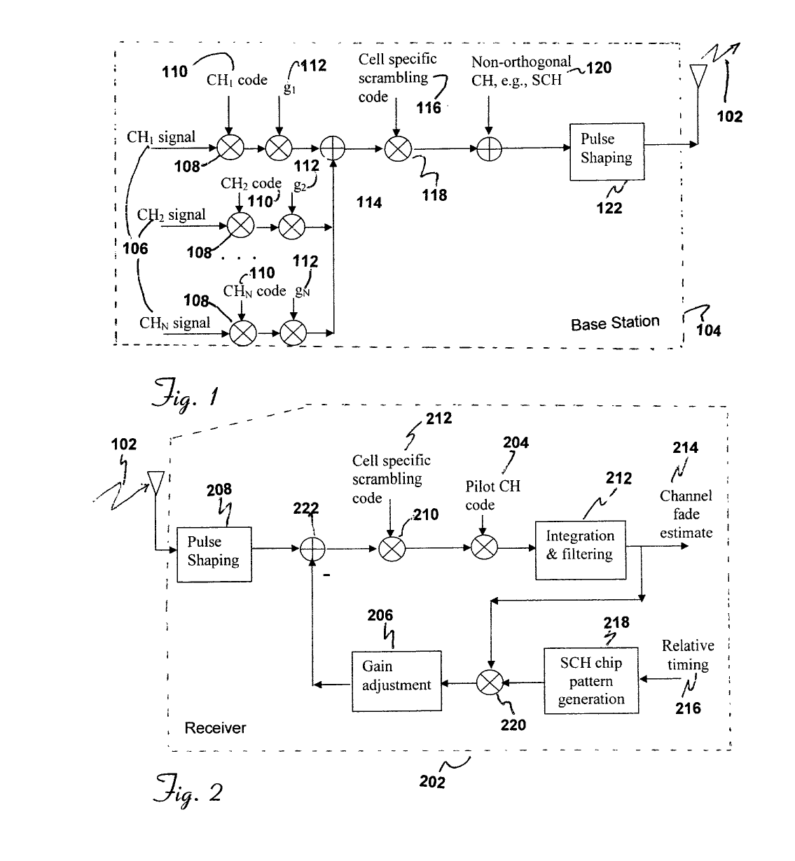

In WCDMA, cell specific scrambling codes are used at different cells to distinguish signal from different cells. This is essential for CDMA systems to have universal frequency re-use everywhere without causing excess co-channel interference. In order to minimize the intra-cell interference in the downlink (the link between base station and terminal), usually orthogonal modulation is used among different channels where each channel typically carries signal for different users or for different services of the same user. FIG. 1 shows a typical example of WCDMA downlink transmission 102 from base station 104 to mobile terminal (not shown). Orthogonal code channels CH₁ to CH_{N} 106 are modulated 108 with orthogonal codes 110 with the same timing and thus create no mutual interference at the receiver as long as the receiver demodulates the desired channel with the correct orthogonal channel code. Each code channel 106 can use different gain (i.e., power) 112 in order to achieve its individual target error rate. The code channels 106 are added 114 and then a cell specific scrambling code 116 is applied 118. Note that due to the usage of cell specific scrambling codes 116, the signal from other base stations can not be orthogonal with the signal from the serving base station and thus will create interference. Pilot code channel which provides the pilot signal for channel fade detection can use one of the orthogonal code channels.

CDMA systems such as IS-95 systems maintain system synchronization among all base stations by using the global positioning system (GPS) timing. Therefore, for IS-95 type CDMA systems, the cell specific scrambling codes are chosen from one exact scrambling sequence but different offsets. The terminal is thus easier to detect and synchronize with the system by continuously search the same scrambling code with different hypotheses on code phase offsets.

However, WCDMA system is designed to waive the need of using synchronous timing sources among base stations such as GPS. Therefore, WCDMA system has chosen to use asynchronous base stations among which the timing is not synchronized. For this kind of asynchronous CDMA systems, it is very difficult and time consuming for a terminal to detect and synchronize with different base stations as they use different cell specific scrambling codes with unknown code phase offsets. This presents a huge challenge especially in the stage of terminal power on to search for initial services.

To save such problem, WCDMA has implemented specific synchronization channels (SCH) 120. At each base station, primary SCH (P-SCH) transmits a special chip pattern which is the same for all base stations while secondary SCH (S-SCH) transmits another special chip pattern which is different based on which group the base station belongs to. In other words, base stations within the same SCH code group, they will transmit the same chip pattern in S-SCH but base stations of different SCH code groups will transmit different chip pattern in S-SCH. To prevent confusion to the terminal, the base station deployment will make sure within one area, at most one base station's signal will be detected from the same SCH code group.

Since the SCHs 120 are used to facilitate fast synchronization for terminal to the base stations, the SCHs (P-SCH and S-SCH) 120 are not modulated with cell specific scrambling codes. Therefore the SCHs 120 can not maintain the orthogonality to the signal from the same base station. In other words, the signal at the SCHs 120 and the signal at other code channels 106 from the same base station will generate mutual interference at the receiver. This interference will degrade either in performance or capacity.

To alleviate such problem, this invention proposes a scheme to cancel the interference/signal from the SCHs 120 at the receiver when detecting other desired code channels.

In the downlink of a CDMA system, usually all signals from the same base station are modulated with an orthogonal channel coding such that the signal at different code channels are orthogonal thus creating no mutual interference at the receiver. However, in some cases such arrangement of orthogonal modulation is not possible. For instance, the Synchronization Channel (SCH) in WCDMA can not be orthogonal to other code channels due to the application of cell-specific scrambling codes at other code channels. Therefore the SCH signal creates interference to other code channels' signal. In the detection of other code channels such as user data channel (DPCH) or broadcast channel (BCH) etc., the interference from SCH causes degradation and is desired to be removed. The method and apparatus in this invention first uses the channel estimate via pilot signal to reconstruct the signal at non-orthogonal code channel (e.g., SCH). Then such reconstructed signal is removed (subtracted) from the received signal before the decoding and detection of other code channels. The cancellation of interference from non-orthogonal signal can significantly improve the performance of the detection of the desired signal (user data or broadcast data) and thus more system capacity can be obtained.

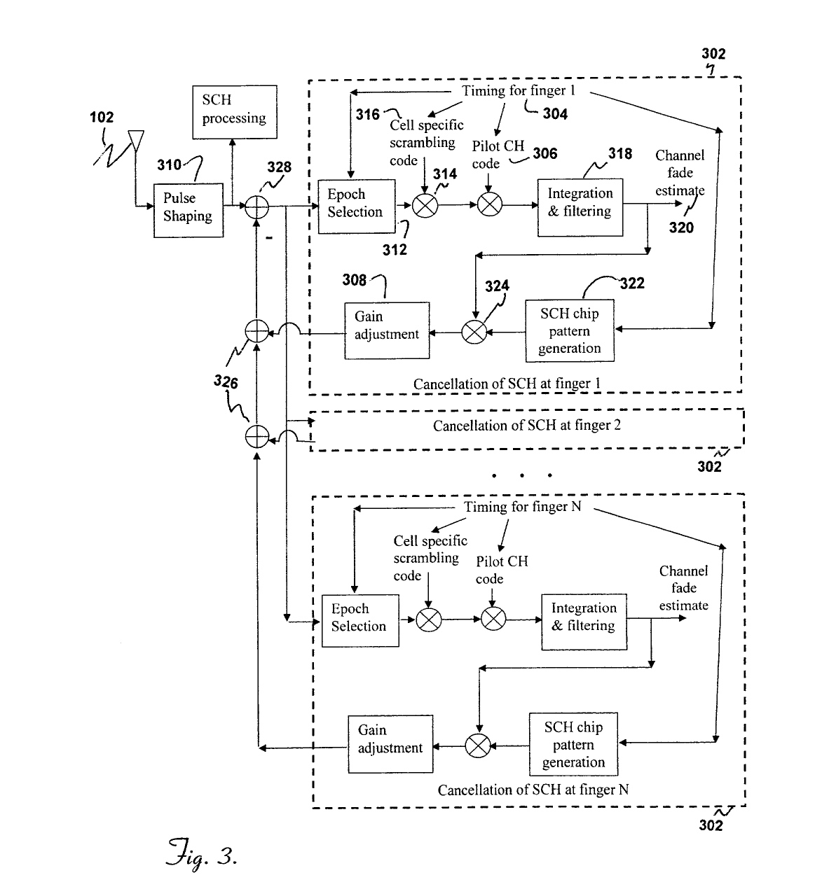

FIG. 2 is a block diagram of the architecture to suppress the interference from non-orthogonal channels in a typical WCDMA downlink transmission. In the receiver 202 architecture to suppress the interference from non-orthogonal channels in a typical WCDMA downlink transmission 102, SCH is the target non-orthogonal channel to be suppressed. The channel fade estimate is produced based on the pilot code channel (e.g., P-CPICH in WCDMA) 204. The gain adjustment 206 is based on the known power ratio between pilot code channel 204 and SCH. After the pulse shaping filter 208, the signal is multiplied 210 with cell specific scrambling code 212 and then the orthogonal code that is assigned to pilot code channel 204. The resultant signal is then integrated over the orthogonal duration (in WCDMA system, this is 256 chips) and then is operated with some filtering process 212. The filtering process to generate channel fade estimate can be an FIR or IIR type operation. The process thus generates the channel fade estimate 214.

A relative timing 216 is assumed obtained from earlier synchronization process and pilot correlation process. The timing is used to generate 218 the P-SCH and S-SCH chip patterns as defined in the WCDMA standard. The generated chip patterns are multiplied 220 with the channel fade estimate 214 and then properly adjusted the gain to reconstruct the P-SCH and S-SCH signal at the receiver. The gain adjustment 206 is based on the known power ratio between pilot code channel 204 and SCHs. The reconstructed SCH signal is then subtracted 220 from the total received signal to minimize the interference from SCH to other desired code channels.

The previous description is an example of canceling the non-orthogonal signal from the same base station. There can be varieties of ways of doing so. For instance, the channel fade estimate may be obtained from pilot symbols that are transmitted within certain code channels instead of the pilot code channel. There can be other non-orthogonal code channels in future CDMA systems other than SCH for other purposes. The interference from these non-orthogonal channels can be suppressed by using the scheme proposed in this invention.

FIG. 3 is a block diagram of an exemplary embodiment of SCH interference cancellation for multiple fingers scenarios (e.g., multi-path environment and/or with soft handoff). Due to different timing offsets among fingers, the SCHs and other channel code generation should be based on the timing of individual fingers. The scenarios of such multiple fingers operation represents the cases of multi-path environment and/or with soft handoff operation where at least one finger is assigned to each base station that is involved in the soft handoff.

The architecture to suppress the interference from non-orthogonal channels in a typical WCDMA downlink transmission 102 in a multi-path environment involves the cancellation of non-orthogonal channel such as SCH at each finger 302. The channel fade estimate is produced based on the pilot code channel (e.g., P-CPICH in WCDMA) 206 which is based on the timing the particular finger 304. The gain adjustment 308 is based on the known power ratio between pilot code channel 306 and SCH. After the pulse shaping filter 310, epoch selection 312 based on the timing the particular finger 304 the signal is multiplied 314 with cell specific scrambling code 316 and then the orthogonal code that is assigned to pilot code channel 306. The resultant signal is then integrated over the orthogonal duration (in WCDMA system, this is 256 chips) and then is operated with some filtering process 318. The filtering process to generate channel fade estimate can be an FIR or IIR type operation. The process thus generates the channel fade estimate 320.

The spreading codes used for the exemplary system of the present invention have a number of chips after which the code repeats. The repetition period of the spreading sequence is called an epoch.

Timing for the particular finger 304 is used to generate 322 the P-SCH and SSCH chip patterns as defined in the WCDMA standard. The generated chip patterns are multiplied 324 with the channel fade estimate 320 and then properly adjusted the gain to reconstruct the P-SCH and S-SCH signal at the receiver. The gain adjustment 308 is based on the known power ratio between pilot code channel 306 and SCHs.

The reconstructed SCH signals for each finger is added 326 with the result then being subtracted 328 from the total received signal to minimize the interference from SCH to other desired code channels.

It should be noted that the present invention, method and apparatus to estimate the channel fade, is equally well suited for use with other wireless communication systems (not just CDMA). For example, TDMA systems also require channel estimate in the receiver operation. Similar technique can be easily applied to those systems.

Numerous modifications and alternative embodiments of the invention will be apparent to those skilled in the art in view of the foregoing description. Accordingly, this description is to be construed as illustrative only and is for the purpose of teaching those skilled in the art the best mode of carrying out the invention. Details of the structure may be varied substantially without departing from the spirit of the invention and the exclusive use of all modifications, which come within the scope of the appended claim, is reserved.

What is claimed:

1. A method for canceling non-orthogonal code channel signals in a received signal to minimize interference comprising the following steps:
reconstructing signal at non-orthogonal code channel; and,
subtracting the reconstructed signal from the received signal.

2. The method as recited in claim 1 further comprising the step of decoding and detecting other code channels after subtracting the reconstructed signal from the received signal.

3. The method as recited in claim 1 further comprising the step of using channel estimate via pilot signal to reconstruct the signal at the non-orthogonal code channel.

4. The method as recited in claim 1 wherein the non-orthogonal code channel is a synchronization channel.

5. The method as recited in claim 4 wherein the synchronization channel is a WCDMA synchronization channel.

6. The method as recited in claim 1 wherein reconstructing the signal at the non-orthogonal code channel is done in a mobile receiver.

7. The method as recited in claim 1 wherein channel estimate via pilot signal is based on timing of a particular finger of a plurality of fingers.

8. A digital radio system for receiving a plurality of signals, comprising:
a digital wireless rake receiver having a plurality of finger signals;
means for reconstructing signal at non-orthogonal code channel; and,
means for subtracting the reconstructed signal from the received signal.

9. The digital radio system as recited in claim 8 further comprising means for decoding and detecting other code channels after subtracting the reconstructed signal from the received signal.

10. The digital radio system as recited in claim 8 further comprising means for using channel estimate via pilot signal to reconstruct the signal at the non-orthogonal code channel.

11. The digital radio system as recited in claim 8 wherein the non-orthogonal code channel is a WCDMA synchronization channel.

12. The digital radio system as recited in claim 8 wherein means for reconstructing the signal at the non-orthogonal code channel is in a mobile receiver.

13. A signal processor for a digital wireless receiver having a plurality of signals, the signal processor comprising:
a processing circuit for processing the plurality of signals and providing a processed signal, wherein a non-orthogonal code channel is reconstructed and then subtracted from the received signal.

14. The signal processor for a digital wireless receiver as recited in claim 13 further comprising means for decoding and detecting other code channels after the reconstructed signal is subtracted from the received signal.

15. The signal processor for a digital wireless receiver as recited in claim 13 further comprising means for using channel estimate via pilot signal to reconstruct the signal at the non-orthogonal code channel.

16. The signal processor for a digital wireless receiver as recited in claim 13 wherein the non-orthogonal code channel is a WCDMA synchronization channel.
